(19) United States
(12) Patent Application Publication
(10) Pub. No.: US 2019/0164174 A1
(43) Pub. Date: May 30, 2019

(54) INTERNET-BASED MULTI-LEVEL TWO-DIMENSIONAL CODE ANTI-COUNTERFEITING METHOD, DEVICE AND SYSTEM

(71) Applicant: Hongde SHEN, SHENZHEN (CN)

(72) Inventor: Hongde SHEN, SHENZHEN (CN)

(21) Appl. No.: 16/263,219

(22) Filed: Jan. 31, 2019

Related U.S. Application Data
(63) Continuation of application No. PCT/CN2016/000645, filed on Nov. 21, 2016.

(30) Foreign Application Priority Data
Aug. 10, 2016 (CN) 201610654459.2

(51) Int. Cl. G06Q 30/00; G06K 19/06; G06K 17/00

(52) U.S. Cl. CPC G06Q 30/0185; G06K 17/0022; G06K 19/06037

(57) ABSTRACT

An Internet-based multi-level two-dimensional code anti-counterfeiting method includes: S1. generating two-dimensional code groups corresponding to each commodity in a one-to-one manner, and uploading to an anti-counterfeiting system, each two-dimensional code group including at least one disclosed first two-dimensional code and one undisclosed second two-dimensional code, and the second two-dimensional code being unidirectionally associated with information of the first two-dimensional code; S2. reading the first two-dimensional code, and simultaneously activating the second two-dimensional code; S3. reading information of the second two-dimensional code, and linking to the anti-counterfeiting system; S4. judging whether a commodity is a genuine commodity; S5. capturing commodity information of the first two-dimensional code associated with the second two-dimensional code; S6. downloading the commodity information of the first two-dimensional code to a client of a user for displaying; and S7. sending feedback information that the commodity is not a genuine commodity to the user.

### CROSS-REFERENCE TO RELATED APPLICATIONS

This application is a continuation of International Patent Application No. PCT/CN2016/000645 with a filing date of Nov. 21, 2016, designating the United States, now pending, and further claims priority to Patent Application No. 201610654459.2 with a filing date of Aug. 10, 2016. The content of this aforementioned applications, including any intervening amendments thereto, are incorporated herein by reference.

### TECHNICAL FIELD

The present disclosure relates to the field of two-dimensional codes, and particularly relates to an Internet-based multi-level two-dimensional code anti-counterfeiting method, device and system.

### BACKGROUND OF THE PRESENT INVENTION

Two-dimensional codes have been applied to all aspects of our life, such as subway advertisement, newspaper, train tickets, plane tickets, fast food restaurants, movie theaters, group-buying websites and various outer packages of commodities. As a link in the Internet of things wave industry, the application of the two-dimensional codes has never been so concerned. With the rapid development of the Internet of things industry in China, the cooperation of the two-dimensional codes and mobile phone cameras and the cooperation of the two-dimensional codes and computers produce a variety of applications. We can print the two-dimensional codes on our business cards. Others can simply scan the two-dimensional codes with a camera phone equipped with two-dimensional code recognition software and input all kinds of information on the business cards into the phone. If the two-dimensional codes are also printed on commodities in a supermarket, a lot of detailed information about the commodities can be obtained on the mobile phone.

With the wide application of the two-dimensional code technology, how to track the production and circulation information of the commodities through the two-dimensional code information on the commodities, how to realize the record of the use process, and how to realize prevention of tampering, swapping or misappropriation become the subjects of people.

### SUMMARY OF PRESENT INVENTION

To solve the above problems, the present disclosure provides an Internet-based multi-level two-dimensional code anti-counterfeiting method, device and system.

The present disclosure discloses an Internet-based multi-level two-dimensional code anti-counterfeiting method, including:

S1. generating two-dimensional code groups corresponding to each commodity in a one-to-one manner, and uploading to an anti-counterfeiting system, each two-dimensional code group including at least one disclosed first two-dimensional code and one undisclosed second two-dimensional code, and the second two-dimensional code being unidirectionally associated with information of the first two-dimensional code;

S2. reading the first two-dimensional code; after reading by a two-dimensional code reading device, uploading information related to production time of the commodity, a place, composition and quality inspection of the commodity to the anti-counterfeiting system in real time through an appointed IP address; and simultaneously activating the second two-dimensional code while reading the first two-dimensional code;

S3. reading information of the second two-dimensional code, and linking to the anti-counterfeiting system;

S4. judging whether a commodity is a genuine commodity: if so, entering step S5; if not, entering step S7;

S5. capturing commodity information of the first two-dimensional code associated with the second two-dimensional code;

S6. downloading the commodity information of the first two-dimensional code from a server of the anti-counterfeiting system to a client of a user for displaying; and

S7. sending feedback information that the commodity is not a genuine commodity to the user.

Further, the step S4 specifically includes the following steps:

S41. sending feedback information that the commodity is a genuine commodity and sending a re-reading verification code generated by the anti-counterfeiting system to the user if the undisclosed second two-dimensional code is readable by the anti-counterfeiting system and is read for the first time; and entering step S5;

S42. prompting by the anti-counterfeiting system that the second two-dimensional code is read for the Nth time and reminding the user to input the re-reading verification code sent by the anti-counterfeiting system if the undisclosed second two-dimensional code is readable by the anti-counterfeiting system but is not read for the first time; sending feedback information that the commodity is confirmed as the genuine commodity if the verification code passes system verification; entering step S5; entering step S7 if the verification code does not pass system verification, wherein N is an integer greater than 1; and

entering step S7 if the undisclosed second two-dimensional code is not readable by the anti-counterfeiting system.

Further, the step S1 further includes the following steps:

correspondingly generating two-dimensional codes of different group and/or box and/or batch packages at the time of group and/or box and/or batch packaging after production, and correspondingly conducting the following steps:

adding the first two-dimensional code information of each commodity to the two-dimensional code information of the group packages, and uploading to the anti-counterfeiting system;

adding the two-dimensional code information of each group package to the two-dimensional code information of the box packages, and uploading to the anti-counterfeiting system;

adding the two-dimensional code information of each box package to the two-dimensional code information of the batch packages, and uploading to the anti-counterfeiting system; and

reading the two-dimensional codes of the group and/or box and/or batch packages, and automatically uploading the information of circulation and sale processes in real time to the anti-counterfeiting system through links.

The present disclosure discloses an Internet-based multi-level two-dimensional code anti-counterfeiting device, including:

a two-dimensional code generating unit for generating two-dimensional code groups corresponding to each commodity in a one-to-one manner and uploading to an anti-counterfeiting system, each two-dimensional code group including at least one disclosed first two-dimensional code and one undisclosed second two-dimensional code, and the second two-dimensional code being unidirectionally associated with information of the first two-dimensional code;

a first two-dimensional code information reading unit for reading the first two-dimensional code, uploading information related to production time of the commodity, a place, composition and quality inspection of the commodity to the anti-counterfeiting system in real time through an appointed IP address after reading by a two-dimensional code reading device, and simultaneously activating the second two-dimensional code while reading the first two-dimensional code;

a second two-dimensional code information reading unit for reading information of the second two-dimensional code, and linking to the anti-counterfeiting system;

a judging unit for judging whether a commodity is a genuine commodity: if so, entering an associated information capturing unit and if not, entering a non-genuine commodity information feedback unit;

an associated information capturing unit for capturing commodity information and related information of the first two-dimensional code associated with the second two-dimensional code;

an information downloading unit for downloading the commodity information and the related information of the first two-dimensional code from a server of the anti-counterfeiting system to a client of a user for displaying; and

a non-genuine commodity information feedback unit for sending feedback information that the commodity is not a genuine commodity to the user.

Further, the judging unit specifically includes the following units:

a first-reading judging unit for sending feedback information that the commodity is a genuine commodity and sending a re-reading verification code generated by the anti-counterfeiting system to the user if the undisclosed second two-dimensional code is readable by the anti-counterfeiting system and is read for the first time, and entering the associated information capturing unit;

a re-reading judging unit for prompting by the anti-counterfeiting system that the second two-dimensional code is read for the Nth time and reminding the user to input the re-reading verification code sent by the anti-counterfeiting system if the undisclosed second two-dimensional code is readable by the anti-counterfeiting system but is not read for the first time, sending feedback information that the commodity is confirmed as the genuine commodity if the verification code passes system verification, and entering the non-genuine commodity information feedback unit if the verification code does not pass system verification, wherein N is an integer greater than 1; and

a third reading unit used for entering the non-genuine commodity information feedback unit if the second two-dimensional code is not readable by the anti-counterfeiting system.

Further, the two-dimensional code generating unit further includes:

a commodity circulation two-dimensional code generating unit for correspondingly generating two-dimensional code groups of different group and/or box and/or batch packages at the time of group and/or box and/or batch packaging after production, and correspondingly conducting the following steps:

adding the first two-dimensional code information to the two-dimensional code information of the group packages, and uploading to the anti-counterfeiting system;

adding the two-dimensional code information of each group package to the two-dimensional code information of the box packages, and uploading to the anti-counterfeiting system;

adding the two-dimensional code information of each box package to the two-dimensional code information of the batch packages, and uploading to the anti-counterfeiting system; and

reading the two-dimensional codes of the group and/or box and/or batch packages, and automatically uploading the information of circulation and sale processes in real time to the anti-counterfeiting system through links.

The present disclosure discloses an Internet-based multi-level two-dimensional code anti-counterfeiting system, including a server, a controller connected with the server, a two-dimensional code generating device and at least one client communicated with the server, wherein the controller includes the above Internet-based multi-level two-dimensional code anti-counterfeiting device.

Further, the server is communicated with the client through Internet, WIFI, 3G, 4G, 5G, Bluetooth or GPRS.

The Internet-based multi-level two-dimensional code anti-counterfeiting method, device and system according to the present disclosure have the following beneficial technical effects:

The technical solution of the present disclosure can track the production and circulation information of the commodities through the information of the first two-dimensional code corresponding to each commodity in a one-to-one manner to realize traceability of the whole process information of the commodities, and can verify the authenticity of the commodities through the information of the second two-dimensional code, thereby realizing multi-level prevention of counterfeiting, tampering, swapping or misappropriation. The present disclosure is especially suitable for protection of customized commodities, medium and high-end commodities and brands, so that there is no fake commodity or counterfeited commodity in the market.

By means of Internet, WIFI, 3G, 4G, 5G, Bluetooth or GPRS and other communication modes, real-time tracking and tracing of material circulation can be realized to help remote repair and maintenance of the device, prevention of counterfeiting and tampering of the products, stimulation of terminal consumers and reengineering of enterprise supply chain process, to further improve customer responsiveness and extend products and services to terminal customer.

Manufacturers can also timely grasp the market dynamics, develop more practical products to meet the needs of the customers, and finally achieve production according to orders, thereby greatly reducing production cost and operation cost.

The promotion and application of the two-dimensional codes are conducive to the tracking of the whole life cycle of the commodities and the scrapping and recycling of the commodities.

### DESCRIPTION OF THE DRAWINGS

To more clearly describe the technical solutions in the embodiments of the present disclosure or in the prior art, the drawings required to be used in the description of the embodiments or the prior art will be simply presented below. Apparently, the drawings in the following description are merely some embodiments of the present disclosure, and for those ordinary skilled in the art, other drawings can also be obtained according to these drawings without contributing creative labor.

FIG. 1 is a flow chart of an Internet-based multi-level two-dimensional code anti-counterfeiting method in an embodiment of the present disclosure;

FIG. 2 is an exploded view of part of steps of FIG. 1 of the present disclosure;

FIG. 3 is a block diagram of an Internet-based multi-level two-dimensional code anti-counterfeiting device in an embodiment of the present disclosure;

FIG. 4 is an exploded view of part of units of FIG. 3 of the present disclosure; and

FIG. 5 is a module diagram of an Internet-based multi-level two-dimensional code anti-counterfeiting system in an embodiment of the present disclosure.

### DETAILED DESCRIPTION OF PREFERRED EMBODIMENTS

Technical solutions in the embodiments of the present disclosure are described clearly and fully below in combination with the drawings in the embodiments of the present disclosure. Apparently, the described embodiments are merely part of the embodiments of the present disclosure, not all of the embodiments. Based on the embodiments in the present disclosure, all other embodiments obtained by those ordinary skilled in the art without contributing creative labor will belong to the protection scope of the present disclosure.

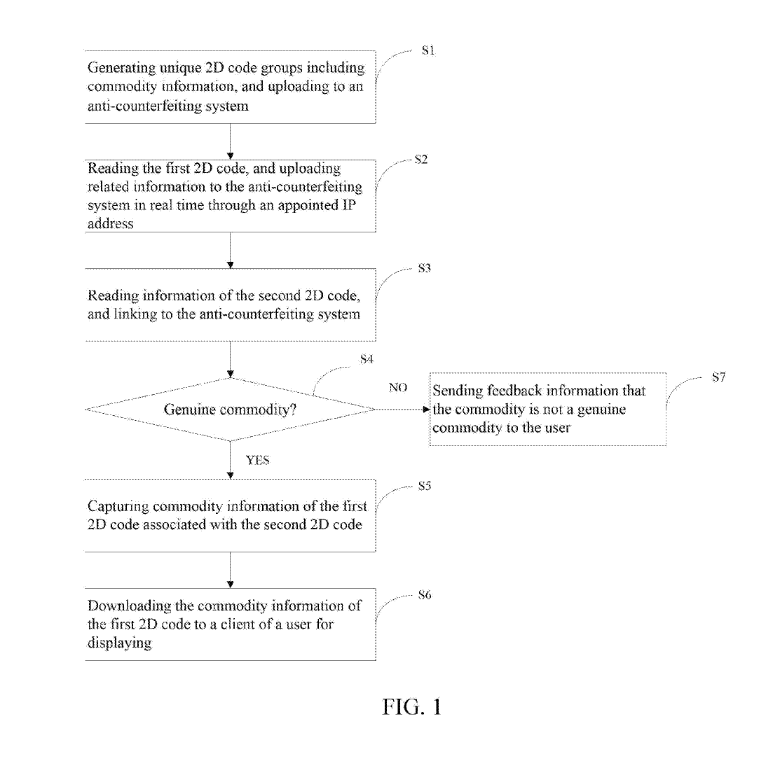

By referring to FIG. 1, an embodiment of a method of the present disclosure provides an Internet-based multi-level two-dimensional code anti-counterfeiting method, including:

S1. generating two-dimensional code groups corresponding to each commodity in a one-to-one manner, and uploading to an anti-counterfeiting system, each two-dimensional code group including at least one disclosed first two-dimensional code and one undisclosed second two-dimensional code, and the second two-dimensional code being unidirectionally associated with information of the first two-dimensional code.

The two-dimensional code is actually a digital matrix composed of many 0 and 1. The two-dimensional code records data symbol information by means of black and white graphs that are distributed in a plane (in a 2-dimensional direction) based on a certain rule according to a specific geometric pattern. In coding, the concept of “0” and “1” bit streams which form the logic foundation in a computer is skillfully used; the numerical information of characters is represented with several geometric shapes corresponding to a binary system or a quaternary system; and automatic reading is conducted by an image input device or a photoelectric reading device to realize automatic information processing: the two-dimensional code has some common characteristics of bar code technology: each code system has a specific character set; each character occupies a certain width; and the two-dimensional code has a certain check function. Meanwhile, the two-dimensional code also has the function of automatically identifying and processing the information of different lines and processing the rotation and change of the graphs. The two-dimensional code can express the information horizontally and vertically, and thus can express a large amount of information in a small area.

The two-dimensional codes of products and components are coded and managed in the production process, and are synchronously uploaded to the system. The two-dimensional codes of the production link can be used to manage the production process and record production dates, ingredients, compositions, instructions and notes, can avoid errors in the production process and improve the production efficiency, and can realize flexible customization production.

Each commodity has its own two-dimensional code identity, and the disclosed first two-dimensional code can be printed on a label and a package of the commodity. The undisclosed second two-dimensional code is printed at a key part of the unwrapped commodity package (this part cannot be recovered without any trace once unwrapped) or a key part of the unwrapped commodity (this part cannot be recovered without any trace once unwrapped). The undisclosed second two-dimensional code can also be printed in a sealed order or on a carrier in another hidden mode. The sealed order or the carrier is placed in the commodity package or is connected with the commodity into a whole.

The system at least includes the two-dimensional code reading functions of a multi-level two-dimensional code generating device, a background server, anti-counterfeiting software, anti-counterfeiting two-dimensional code APP reading software of an intelligent terminal, or Wechat and Facebook.

The anti-counterfeiting system generates a two-dimensional code group corresponding to each commodity. The two-dimensional code group belongs to the same commodity after being read.

Further, two-dimensional codes of different group and/or box and/or batch packages at the time of group and/or box and/or batch packaging after production of the commodities can be generated, and the following steps are conducted:

adding the first two-dimensional code information to the two-dimensional code information of the group packages, and uploading to the anti-counterfeiting system; and/or adding the two-dimensional code information of each group package to the two-dimensional code information of the box packages, and uploading to the anti-counterfeiting system; and/or adding the two-dimensional code information of each box package to the two-dimensional code information of the batch packages, and uploading to the anti-counterfeiting system; and

reading the two-dimensional codes of the group and/or box and/or batch packages, and automatically uploading the information of circulation and sale processes in real time to the anti-counterfeiting system through links.

In the sales process of the products, the first two-dimensional code described in each commodity is read and managed, and the sales time, sales place and shelf time are recorded. At the same time, a product quality problem can be traced, and food safety, tracing of agricultural products and product management of warranty and anti-channel conflict can be enhanced.

The above steps can be implemented in part or in whole depending on the circulation of the commodities.

S2. Reading the first two-dimensional code; after reading by a two-dimensional code reading device, uploading information related to production time of the commodity, a place, composition and quality inspection of the commodity to the anti-counterfeiting system in real time through an appointed IP address; and simultaneously activating the second two-dimensional code while reading the first two-dimensional code.

S3. Reading information of the second two-dimensional code, and linking to the anti-counterfeiting system.

When the terminal consumer or the user purchases or uses the commodity, the undisclosed second two-dimensional code (hidden two-dimensional code) is started at the key part of the commodity or at the key part of the unwrapped commodity package; and special supporting APP software is downloaded through smart mobile terminals such as smart phones, or the undisclosed second two-dimensional code is read by the two-dimensional code reading function of Wechat and Facebook.

The undisclosed second two-dimensional code information is read and is directly linked to a verification and judgment subsystem of the anti-counterfeiting system to enter step S4.

S4. Judging whether a commodity is a genuine commodity: if so, entering step S5; if not, entering step S7.

In order to prevent fake products, the undisclosed second two-dimensional code is used to verify whether the commodities are genuine.

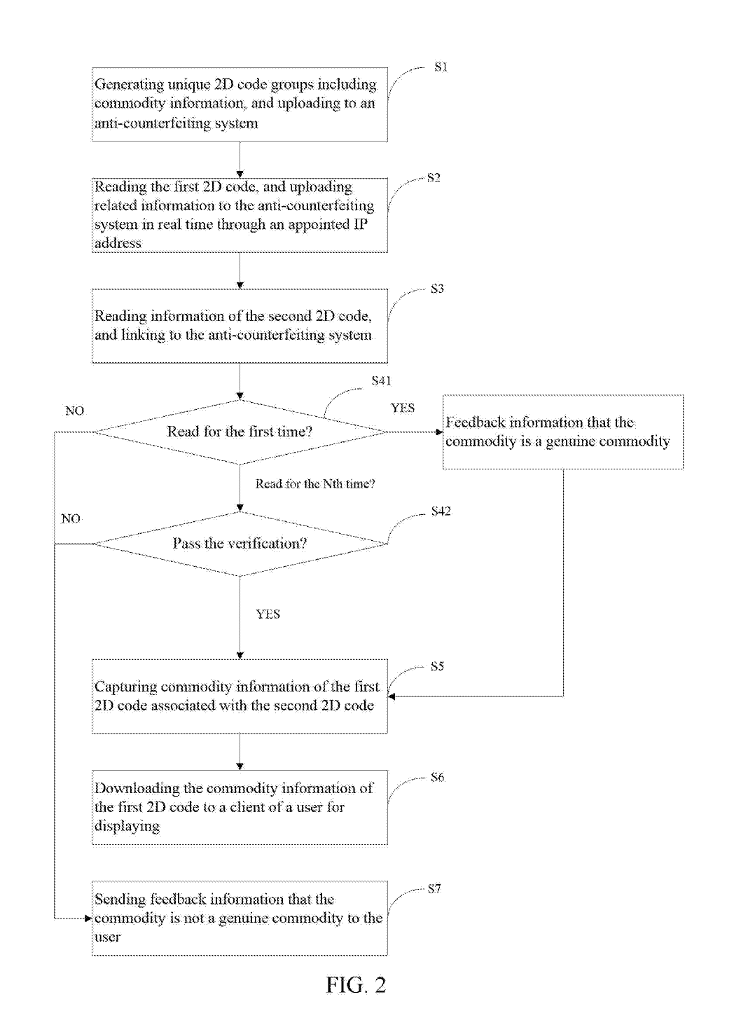

Further, by referring to FIG. 2, the solution specifically includes the following steps:

S41. sending feedback information that the commodity is a genuine commodity and sending a re-reading verification code generated by the anti-counterfeiting system to the user if the undisclosed second two-dimensional code is readable by the anti-counterfeiting system and is read for the first time; and entering step S4;

S42. prompting by the anti-counterfeiting system that the second two-dimensional code is read for the Nth time and reminding the user to input the re-reading verification code sent by the anti-counterfeiting system if the undisclosed second two-dimensional code is readable by the anti-counterfeiting system but is not read for the first time; sending feedback information that the commodity is confirmed as the genuine commodity if the verification code passes system verification; entering step S4; entering step S6 if the verification code does not pass system verification, wherein N is an integer greater than 1; and

entering step S7 if the undisclosed second two-dimensional code is not readable by the anti-counterfeiting system.

The undisclosed second two-dimensional code of each commodity mentioned above is only used for the final terminal consumer or user to verify the authenticity of commodities. The undisclosed second two-dimensional code can be hidden in different ways according to the features of different types of commodities.

S5. Capturing commodity information and related information of the first two-dimensional code associated with the second two-dimensional code.

S6. Downloading the commodity information and related information of the first two-dimensional code from a server of the anti-counterfeiting system to a client of a user for displaying.

In the Internet or mobile Internet business mode, human operating activities are more extensive, so it is more necessary to timely exchange and share the information. With the popularity of smart phones and tablet personal computers in 3G/4G/5G and other mobile network environments, the application of the two-dimensional codes is not limited by time, space and hardware devices.

S7. Sending feedback information that the commodity is not a genuine commodity to the user.

The feedback information that the commodity is not a genuine commodity is sent to the user if the undisclosed second two-dimensional code is not readable by the anti-counterfeiting system. The anti-counterfeiting system prompts that the second two-dimensional code is read for the Nth time and reminds the user to input the re-reading verification code sent by the anti-counterfeiting system if the undisclosed second two-dimensional code is readable by the anti-counterfeiting system but is not read for the first time. The feedback information that the commodity is not a genuine commodity is sent to the user if the verification code does not pass system verification, wherein N is an integer greater than 1.

A device of realizing the Internet-based multi-level two-dimensional code anti-counterfeiting method is introduced below. For parts not stated in the device, refer to the above record in the method.

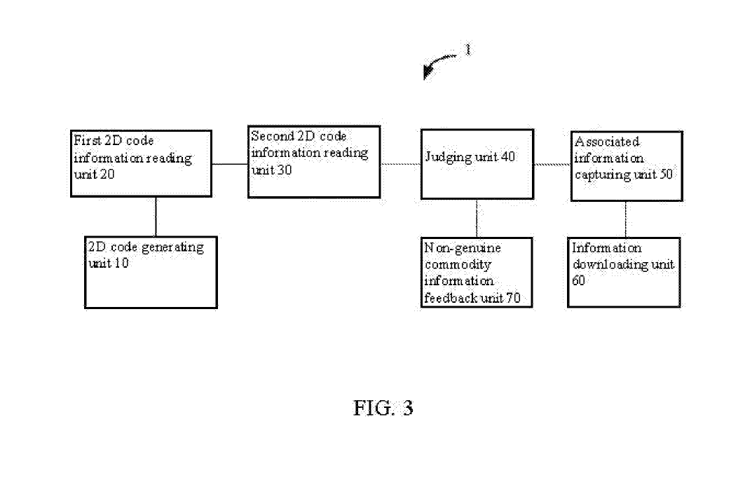

By referring to FIG. 3, an Internet-based multi-level two-dimensional code anti-counterfeiting device 1 is used for realizing the above method and includes:

a two-dimensional code generating unit 10 for generating two-dimensional code groups corresponding to each commodity in a one-to-one manner and uploading to an anti-counterfeiting system, each two-dimensional code group including at least one disclosed first two-dimensional code and one undisclosed second two-dimensional code, and the second two-dimensional code being unidirectionally associated with information of the first two-dimensional code;

a first two-dimensional code information reading unit 20 for reading the first two-dimensional code, uploading information related to production time of the commodity, a place, composition and quality inspection of the commodity to the anti-counterfeiting system in real time through an appointed IP address after reading by a two-dimensional code reading device, and simultaneously activating the second two-dimensional code while reading the first two-dimensional code;

a second two-dimensional code information reading unit 30 for reading information of the second two-dimensional code, and linking to the anti-counterfeiting system;

a judging unit 40 for judging whether a commodity is a genuine commodity: if so, entering an associated information capturing unit 50 and if not, entering a non-genuine commodity information feedback unit 70;

an associated information capturing unit 50 for capturing commodity information and related information of the first two-dimensional code associated with the second two-dimensional code;

an information downloading unit 60 for downloading the commodity information and the related information of the first two-dimensional code from a server of the anti-counterfeiting system to a client of a user for displaying; and

a non-genuine commodity information feedback unit 70 for sending feedback information that the commodity is not a genuine commodity to the user.

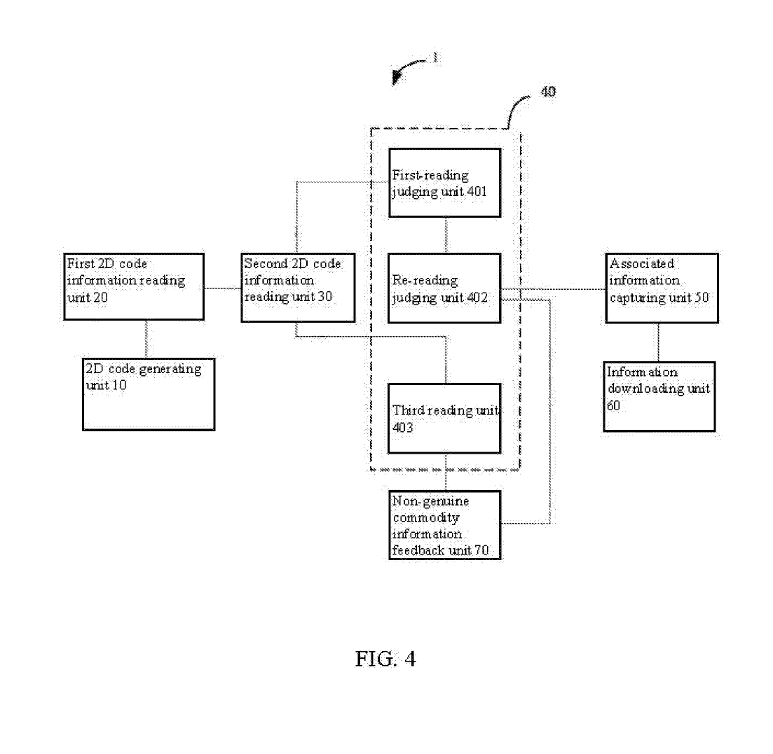

Further, by referring to FIG. 4, the judging unit 40 specifically includes the following units:

a first-reading judging unit 401 for sending feedback information that the commodity is a genuine commodity and sending a re-reading verification code generated by the anti-counterfeiting system to the user if the undisclosed second two-dimensional code is readable by the anti-counterfeiting system and is read for the first time, and entering the associated information capturing unit 50;

a re-reading judging unit 402 for prompting by the anti-counterfeiting system that the second two-dimensional code is read for the Nth time and reminding the user to input the re-reading verification code sent by the anti-counterfeiting system if the undisclosed second two-dimensional code is readable by the anti-counterfeiting system but is not read for the first time, sending feedback information that the commodity is confirmed as the genuine commodity if the verification code passes system verification, and entering the non-genuine commodity information feedback unit 70 if the verification code does not pass system verification, wherein N is an integer greater than 1; and

a third reading unit 403 used for entering the non-genuine commodity information feedback unit 70 if the second two-dimensional code is not readable by the anti-counterfeiting system.

Further, the two-dimensional code generating unit 10 includes:

a two-dimensional code generating unit 10 used for generating two-dimensional code groups corresponding to each commodity in a one-to-one manner, and uploading to an anti-counterfeiting system in a production process of the commodity, each two-dimensional code group including at least one disclosed first two-dimensional code and one undisclosed second two-dimensional code, the second two-dimensional code being unidirectionally associated with information of the first two-dimensional code and the commodity information including related information of the production process.

The step of reading the first two-dimensional code specifically includes: reading the first two-dimensional code; uploading information related to production time of the commodity, a place, composition and quality inspection of the commodity to the anti-counterfeiting system in real time through an appointed IP address after reading by a two-dimensional code reading device, and simultaneously activating the undisclosed second two-dimensional code.

The two-dimensional code generating unit 10 further includes:

a commodity circulation two-dimensional code generating unit for correspondingly generating two-dimensional code groups of different group and/or box and/or batch packages at the time of group and/or box and/or batch packaging after production of the commodity, and correspondingly conducting the following steps:

adding the first two-dimensional code information to the two-dimensional code information of the group packages, and uploading to the anti-counterfeiting system;

adding the two-dimensional code information of each group package to the two-dimensional code information of the box packages, and uploading to the anti-counterfeiting system;

adding the two-dimensional code information of each box package to the two-dimensional code information of the batch packages, and uploading to the anti-counterfeiting system; and

reading the two-dimensional codes of the group and/or box and/or batch packages, and automatically uploading the information of circulation and sale processes in real time to the anti-counterfeiting system through links.

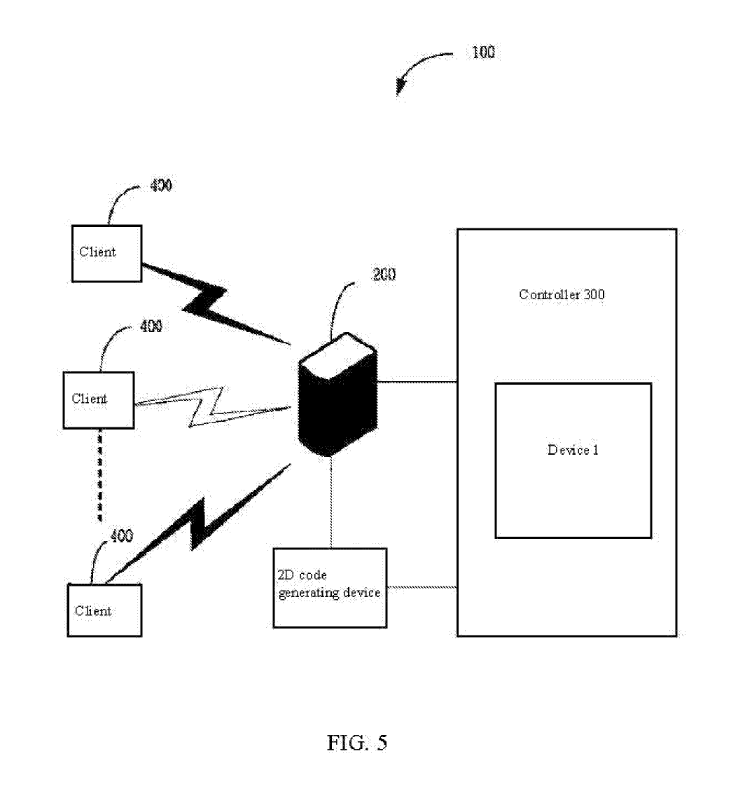

By referring to FIG. 5, an Internet-based multi-level two-dimensional code anti-counterfeiting system 100 includes a server 200, a controller 300 connected with the server 200, a two-dimensional code generating device and at least one client 400 communicated with the server 200, wherein the controller 300 includes the above Internet-based multi-level two-dimensional code anti-counterfeiting device 1.

The server 200 is connected with a management system. The management system may be disposed on the controller 300 and is communicated with the client through WIFI, 3G, 4G, 5G, Bluetooth or GPRS.

Alternatively, the system 100 is essentially a management system of the Internet-based multi-level two-dimensional code anti-counterfeiting system, and includes a server 200, a two-dimensional code generating device connected with the server 200, a controller 300, software and at least one client 400 communicated with the server 200.

When the terminal consumer or the user purchases or uses the commodity, the undisclosed second two-dimensional code (hidden two-dimensional code) is started at the key part of the commodity or at the key part of the unwrapped commodity package; and special supporting APP software is downloaded through smart mobile terminals such as smart phones, or the undisclosed second two-dimensional code is read by the two-dimensional code reading function of Wechat and Facebook. After a link system confirms that the undisclosed second two-dimensional code of the commodity is successfully read for the first time or can be verified by the re-read verification code through a background server: the system 100 sends the information that the commodity is a genuine commodity and sends information related to production time of the commodity, a place, composition, quality inspection and circulation of the commodity to the consumer. When the undisclosed second two-dimensional code is not readable by the anti-counterfeiting system or is not verified by the re-read verification code, the system 100 sends the feedback information that the commodity is not a genuine commodity to the user, and selectively sends information related to production time of the commodity, a place, quality inspection and circulation of the genuine commodity to the consumer according to needs.

The Internet-based multi-level two-dimensional code anti-counterfeiting method, device and system according to the present disclosure have the following beneficial technical effects:

The technical solution of the present disclosure can track the production and circulation information of the commodities through the information of the first two-dimensional code corresponding to each commodity in a one-to-one manner to realize traceability of the whole process information of the commodities, and can verify the authenticity of the commodities through the information of the second two-dimensional code, thereby realizing multi-level prevention of counterfeiting, tampering, swapping or misappropriation. The present disclosure is especially suitable for protection of customized products, medium and high-end commodities and brands, so that there is no fake commodity or counterfeited commodity in the market.

By means of Internet, WIFI, 3G, 4G, 5G, Bluetooth or GPRS and other communication modes, real-time tracking and tracing of material circulation can be realized to help remote repair and maintenance of the device, prevention of counterfeiting and tampering of the products, stimulation of terminal consumers and reengineering of enterprise supply chain process, to further improve customer responsiveness and extend products and services to terminal customer.

Manufacturers can also timely grasp the market dynamics, develop more practical products to meet the needs of the customers, and finally achieve production according to orders, thereby greatly reducing production cost and operation cost.

The promotion and application of the two-dimensional codes are conducive to the tracking of the whole life cycle of the commodities and the scrapping and recycling of the commodities.

The above disclosed content is just one preferred embodiment in the present disclosure and is not intended to define the present disclosure. Any change, equivalent replacement and improvement made within the spirit and the principle of the present disclosure shall be included in the protection scope of the present disclosure.

I claim:

1. An Internet-based multi-level two-dimensional code anti-counterfeiting method, comprising:
S1. generating two-dimensional code groups corresponding to each commodity in a one-to-one manner, and uploading to an anti-counterfeiting system, each two-dimensional code group comprising at least one disclosed first two-dimensional code and one undisclosed second two-dimensional code, and the second two-dimensional code being unidirectionally associated with information of the first two-dimensional code;
S2. reading the first two-dimensional code; after reading by a two-dimensional code reading device, uploading information related to production time of the commodity, a place, composition and quality inspection of the commodity to the anti-counterfeiting system in real time through an appointed IP address; and simultaneously activating the second two-dimensional code while reading the first two-dimensional code;
S3. reading information of the second two-dimensional code, and linking to the anti-counterfeiting system;
S4. judging whether a commodity is a genuine commodity: if so, entering step S5; if not, entering step S7;
S5. capturing commodity information of the first two-dimensional code associated with the second two-dimensional code;
S6. downloading the commodity information of the first two-dimensional code from a server of the anti-counterfeiting system to a client of a user for displaying; and
S7. sending feedback information that the commodity is not a genuine commodity to the user.

2. The method according to claim 1, wherein the step S4 specifically comprises the following steps:
S41. sending feedback information that the commodity is a genuine commodity and sending a re-reading verification code generated by the anti-counterfeiting system to the user if the undisclosed second two-dimensional code is readable by the anti-counterfeiting system and is read for the first time; and entering step S5;
S42. prompting by the anti-counterfeiting system that the second two-dimensional code is read for the Nth time and reminding the user to input the re-reading verification code sent by the anti-counterfeiting system if the undisclosed second two-dimensional code is readable by the anti-counterfeiting system but is not read for the first time; sending feedback information that the commodity is confirmed as the genuine commodity if the verification code passes system verification; entering step S5; entering step S7 if the verification code does not pass system verification, wherein N is an integer greater than 1; and
entering step S7 if the undisclosed second two-dimensional code is not readable by the anti-counterfeiting system.

3. The method according to claim 1, wherein the step S1 further comprises the following steps:
correspondingly generating two-dimensional codes of different group and/or box and/or batch packages at the time of group and/or box and/or batch packaging after production, and correspondingly conducting the following steps:
adding the first two-dimensional code information of each commodity to the two-dimensional code information of the group packages, and uploading to the anti-counterfeiting system;
adding the two-dimensional code information of each group package to the two-dimensional code information of the box packages, and uploading to the anti-counterfeiting system;
adding the two-dimensional code information of each box package to the two-dimensional code information of the batch packages, and uploading to the anti-counterfeiting system; and
reading the two-dimensional codes of the group and/or box and/or batch packages, and automatically uploading the information of circulation and sale processes in real time to the anti-counterfeiting system through links.

4. An Internet-based multi-level two-dimensional code anti-counterfeiting device, comprising:
a two-dimensional code generating unit for generating two-dimensional code groups corresponding to each commodity in a one-to-one manner and uploading to an anti-counterfeiting system, each two-dimensional code group comprising at least one disclosed first two-dimensional code and one undisclosed second two-dimensional code, and the second two-dimensional code being unidirectionally associated with information of the first two-dimensional code;
a first two-dimensional code information reading unit for reading the first two-dimensional code, uploading information related to production time of the commodity, a place, composition and quality inspection of the commodity to the anti-counterfeiting system in real time through an appointed IP address after reading by a two-dimensional code reading device, and simultaneously activating the second two-dimensional code while reading the first two-dimensional code;
a second two-dimensional code information reading unit for reading information of the second two-dimensional code, and linking to the anti-counterfeiting system;
a judging unit for judging whether a commodity is a genuine commodity: if so, entering an associated information capturing unit and if not, entering a non-genuine commodity information feedback unit;
an associated information capturing unit for capturing commodity information and related information of the first two-dimensional code associated with the second two-dimensional code;
an information downloading unit for downloading the commodity information and the related information of the first two-dimensional code from a server of the anti-counterfeiting system to a client of a user for displaying; and
a non-genuine commodity information feedback unit for sending feedback information that the commodity is not a genuine commodity to the user.

5. The device according to claim 4, wherein the judging unit specifically comprises:
a first-reading judging unit for sending feedback information that the commodity is a genuine commodity and sending a re-reading verification code generated by the anti-counterfeiting system to the user if the undisclosed second two-dimensional code is readable by the anti-counterfeiting system and is read for the first time, and entering the associated information capturing unit;
a re-reading judging unit for prompting by the anti-counterfeiting system that the second two-dimensional code is read for the Nth time and reminding the user to input the re-reading verification code sent by the anti-counterfeiting system if the undisclosed second two-dimensional code is readable by the anti-counterfeiting system but is not read for the first time, sending feedback information that the commodity is confirmed as the genuine commodity if the verification code passes system verification, and entering the non-genuine commodity information feedback unit if the verification code does not pass system verification, wherein N is an integer greater than 1; and
a third reading unit used for entering the non-genuine commodity information feedback unit if the second two-dimensional code is not readable by the anti-counterfeiting system.

6. The device according to claim 4, wherein the two-dimensional code generating unit further comprises:
a commodity circulation two-dimensional code generating unit for correspondingly generating two-dimensional code groups of different group and/or box and/or batch packages at the time of group and/or box and/or batch packaging after production, and correspondingly conducting the following steps:
adding the first two-dimensional code information to the two-dimensional code information of the group packages, and uploading to the anti-counterfeiting system;
adding the two-dimensional code information of each group package to the two-dimensional code information of the box packages, and uploading to the anti-counterfeiting system;
adding the two-dimensional code information of each box package to the two-dimensional code information of the batch packages, and uploading to the anti-counterfeiting system; and
reading the two-dimensional codes of the group and/or box and/or batch packages, and automatically uploading the information of circulation and sale processes in real time to the anti-counterfeiting system through links.

7. An Internet-based multi-level two-dimensional code anti-counterfeiting system, comprising a server, a controller connected with the server, a two-dimensional code generating device and at least one client communicated with the server, wherein the controller comprises the Internet-based multi-level two-dimensional code anti-counterfeiting device of claim 4.

8. The anti-counterfeiting system according to claim 7, wherein the server is communicated with the client through Internet, WIFI, 3G, 4G, 5G, Bluetooth or GPRS.
